(19) United States
(12) Patent Application Publication
(10) Pub. No.: US 2015/0086254 A1
(43) Pub. Date: Mar. 26, 2015

(54) Image Forming Apparatus

(71) Applicant: Murata Machinery, Ltd., Kyoto-shi (JP)

(72) Inventors: Yoshihiro SHOJO, Kyoto (JP); Kazuyuki Oya, Kyoto (JP); Isao Fukuda, Aichi (JP)

(73) Assignee: Murata Machinery, Ltd., Kyoto-shi (JP)

(21) Appl. No.: 14/482,327

(22) Filed: Sep. 10, 2014

(30) Foreign Application Priority Data
Sep. 24, 2013 (JP) 2013-196863

(51) Int. Cl. G03G 15/20

(52) U.S. Cl. CPC G03G 15/2007
USPC 399/336

(57) ABSTRACT

An image forming apparatus including an image forming unit configured to form an image on a paper with pigment, a heating unit configured to heat the pigment and the paper from one or both surfaces of the paper, a microwave generator, and a microwave applicator arranged downstream of the heating unit and configured to heat the pigment and the paper by applying microwaves generated by the microwave generator.

### CROSS-REFERENCE TO RELATED APPLICATIONS

This application claims the benefit of priority under 35 USC 119 of Japanese patent application no. 2013-196863, filed on Sep. 24, 2013, which is incorporated herein by reference.

### BACKGROUND OF THE INVENTION

1. Field of the Invention

The present invention relates to an image forming apparatus configured to form an image on a paper with pigment.

2. Description of the Related Art

There is conventionally known an image forming apparatus including an image forming unit configured to form an image on a paper with pigment such as ink or toner and a heating unit configured to heat the pigment and the paper. Since the heating unit heats the paper or the like, the ink that adheres to the paper is dried or the toner is fused to the paper.

There is known an image forming apparatus configured to heat the pigment and the paper by applying microwaves. Furthermore, there is known an image forming apparatus configured to fuse the toner on the paper using a heat roller, but the image forming apparatus includes an auxiliary heating unit configured to heat the paper with microwaves to dry the paper before fusing.

Therefore, an object of the present invention is, in consideration of the above-described circumstances, to provide an image forming apparatus capable of efficiently heating pigment and a paper.

### SUMMARY OF THE INVENTION

An image forming apparatus according to the present invention includes an image forming unit configured to form an image on a paper with pigment, a heating unit configured to heat the pigment and the paper from one or both surfaces of the paper, a microwave generator, and a microwave applicator arranged downstream of the heating unit and configured to heat the pigment and the paper by applying microwaves generated by the microwave generator.

With the image forming apparatus according to the present invention, the image forming unit forms the image on the paper with the pigment, and the heating unit heats the pigment and the paper from the one or both surfaces of the paper. Then, the microwave applicator arranged downstream of the heating unit heats the pigment and the paper with microwaves output from the microwave generator, and thus an interior portion and the like of the paper that have not been sufficiently heated by the heating unit can be heated. Therefore, the pigment and the paper can be efficiently heated.

In the image forming apparatus according to another embodiment of the present invention, the image forming unit forms the image on the one surface of the paper with wet-type pigment, and the heating unit heats the pigment and the paper from the other or both surfaces of the paper.

In the image forming apparatus according to another embodiment of the present invention, the heating unit is a heat roller configured to heat the paper from the other or both surfaces of the paper.

In the image forming apparatus according to another embodiment of the present invention, the microwave generator supplies power to the microwave applicator such that a temperature of the pigment that contains a moisturizing agent (for example, glycerin) is higher than a boiling temperature of the moisturizing agent.

In the image forming apparatus according to another embodiment of the present invention, the image forming unit forms the image on the one surface of the paper with dry-type pigment, and the heating unit heats the pigment and the paper from the one or both surfaces of the paper.

In the image forming apparatus according to another embodiment of the present invention, the heating unit is a heat roller configured to heat the paper from the one or both surfaces of the paper.

The image forming apparatus according to another embodiment of the present invention includes a pair of feed belts configured to sandwich and feed the paper. The microwave applicator includes a heat chamber into which microwaves output from the microwave generator are introduced to heat the pigment and the paper. The heat chamber includes a pair of openings through which the paper passes an interior portion of the heat chamber. The pair of feed belts passes through the pair of openings.

The image forming apparatus according to another embodiment of the present invention includes a plurality of feed rollers with the feed belt provided around each outer circumference thereof to cause the pair of feed belts to travel. The heating unit is a heat roller configured to heat the paper from the one or both surfaces of the paper and is one of the plurality of feed rollers.

In the image forming apparatus according to another embodiment of the present invention, the feed belt is heat-resistant and has a mold release property.

As described above, the image forming apparatus according to the present invention provides an excellent effect in that the pigment and the paper can be efficiently heated.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a schematic diagram illustrating main portions of an image forming apparatus according to a first embodiment of the present invention.

FIG. 2 is a schematic drawing illustrating a microwave applicator according to the first embodiment.

FIG. 3 is a schematic diagram illustrating a heat chamber of the microwave applicator according to the first embodiment.

FIG. 4 is an overall schematic drawing illustrating an image forming apparatus according to a second embodiment of the present invention.

FIG. 5 is a schematic diagram illustrating main portions of the image forming apparatus according to the second embodiment.

FIG. 6 is a schematic diagram illustrating main portions of an image forming apparatus according to a further embodiment of the present invention.

FIG. 7 is a schematic diagram illustrating main portions of an image forming apparatus according to a further embodiment of the present invention.

### DETAILED DESCRIPTION OF THE PREFERRED EMBODIMENTS

### A First Embodiment

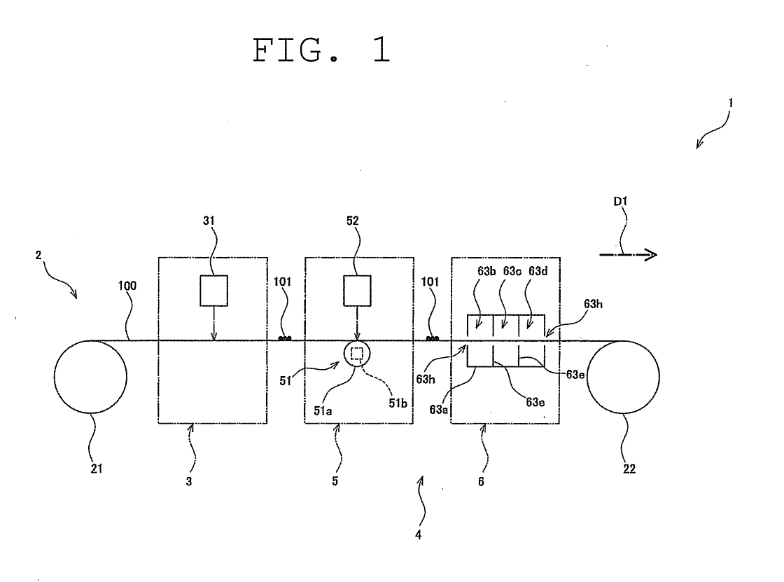

A first embodiment of an image forming apparatus according to the present invention will be hereinafter described with reference to FIGS. 1 to 3.

As illustrated in FIG. 1, an image forming apparatus 1 according to the present embodiment includes a paper feed unit 2 configured to feed a paper 100 along a feed direction D1, an image forming unit 3 configured to form an image on the paper 100 with wet-type pigment 101, and a drying unit 4 configured to dry the wet-type pigment 101. In the present embodiment, the pigment 101 is an ink 101 that contains glycerin.

The paper feed unit 2 includes a supplying unit 21 configured to supply the paper 100 and a recovery unit 22 configured to recover the paper 100 on which the image has been formed. The image forming unit 3 includes a nozzle unit 31 configured to discharge the ink 101 onto one surface of the paper 100.

The drying unit 4 includes a heating unit 5 configured to heat the ink 101 and the paper 100 from both surfaces of the paper 100. In addition, the drying unit 4 includes a microwave applicator 6 configured to heat the ink 101 and the paper 100 with microwaves. The microwave applicator 6 is arranged downstream of the heating unit 5.

The heating unit 5 includes a heat roller 51 configured to make contact with the other surface of the paper 100 to heat the ink 101 and the paper 100 from the other surface of the paper 100. In addition, the heating unit 5 includes a hot-air heater 52 configured to blow hot air towards the one surface of the paper 100 to heat the ink 101 and the paper 100 from the one surface of the paper 100.

The heat roller 51 includes a cylindrical roller unit 51a formed of metal or the like, for example, and heat source 51b arranged inside of the roller unit 51a and configured to heat the roller unit 51a. In the present embodiment, the heat source 51b is a halogen lamp. Since the heat generated from the heat source 51b is propagated to the other surface of the paper 100 via the roller unit 51a, the ink 101 and the paper 100 are heated from the other surface of the paper 100.

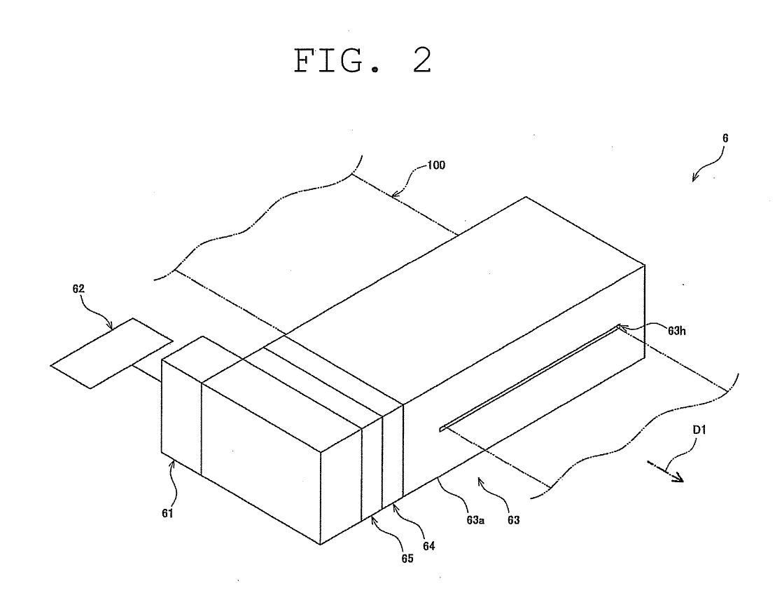

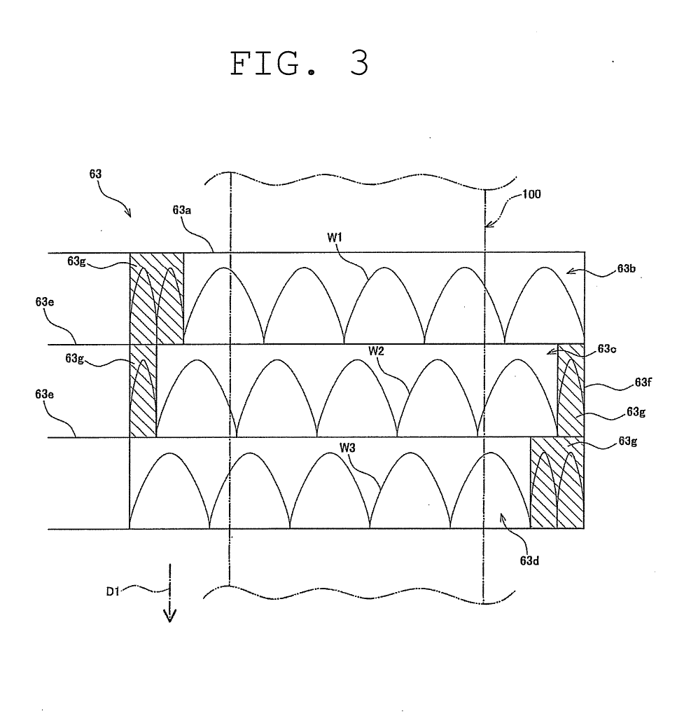

As illustrated in FIGS. 2 and 3, the microwave applicator 6 includes a microwave generator 61 formed of a magnetron that outputs microwaves, and a power supply 62 configured to supply power to the microwave generator 61. The microwave applicator 6 includes a heat chamber 63 into which the microwaves output from the microwave generator 61 are introduced to heat the ink 101 and the paper 100, and a tuner 64 arranged between the microwave generator 61 and the heat chamber 63.

The microwave applicator 6 includes an isolator 65 arranged between the microwave generator 61 and the tuner 64. The isolator 65 is a protection equipment configured, in a case in which microwaves are reflected from the tuner 64 in a direction of the microwave generator 61, to convert power of the reflected microwaves into thermal energy and to stably operate the microwave generator 61.

In the microwave applicator 6, since the power source 62 supplies prescribed power to the microwave generator 61, the ink 101 and the paper 100 reach a temperature (for example, 200° C.) close to a boiling temperature of glycerin or preferably high temperature (for example, 300° C.). Therefore, since the glycerin serving as a moisturizing agent evaporates from the ink 101 heated by the microwave applicator 6, the ink 101 can be more dried.

The heat chamber 63 includes a heat chamber main body 63a formed into a square-tube shape, and a partition plate 63e that partitions the heat chamber main body 63a into a plurality of (three in the present embodiment) rooms 63b to 63d along the feed direction D1. The heat chamber 63 includes a short-circuited plate 63f configured to reflect the microwaves introduced from the microwave generator 61 to form standing waves W1 to W3.

The heat chamber 63 includes a plurality of dielectrics 63g having permittivity higher than air such that phases of the respective standing waves W1 to W3 of the rooms 63b to 63d are shifted from each other by one sixth of a wavelength. Furthermore, the heat chamber 63 includes a pair of openings 63h, 63h through which the paper 100 passes an interior portion of the heat chamber 63.

As described above, with the image forming apparatus 1 according to the present embodiment, the image forming unit 3 forms an image on the paper 100 with the ink 101. The heating unit 5 heats the ink 101 and the paper 100 from both surfaces of the paper 100. Specifically, a hot-air heater 52 heats the one surface of the paper 100 on which the ink 101 has been discharged, and the heat roller 51 heats the other surface of the paper 100.

Then, the microwave applicator 6 arranged downstream of the heating unit 5 heats the ink 101 and the paper 100 with the microwaves output from the microwave generator 61. Consequently, an interior portion of the paper 100 that has not been sufficiently heated by the heating unit 5 and the ink 101 that has infiltrated in the interior portion of the paper 100 can be heated. The ink 101 and the paper 100 thus can be efficiently heated.

### A Second Embodiment

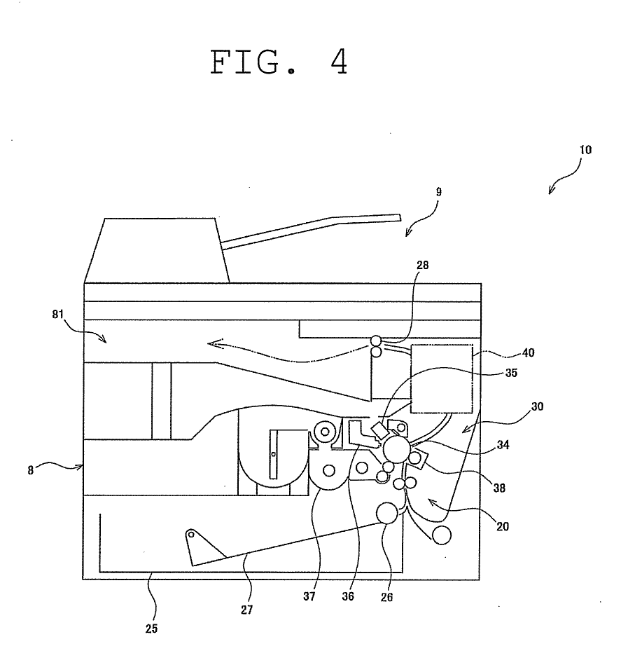

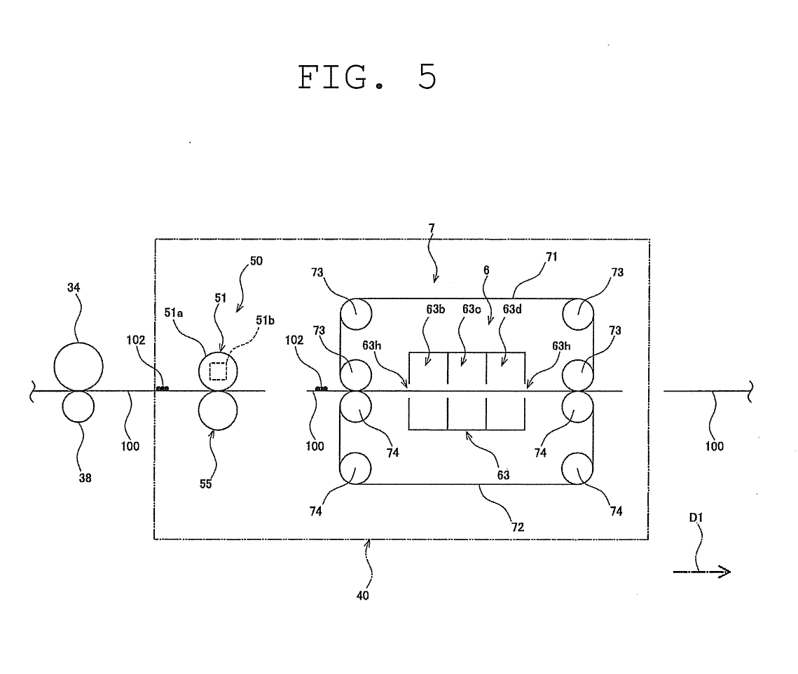

Next, a second embodiment of the image forming apparatus according to the present invention will be described with reference to FIGS. 4 and 5. In FIGS. 4 and 5, parts denoted by the same reference numerals as FIGS. 1 to 3 indicate the same configurations or elements as the first embodiment.

As illustrated in FIG. 4, an image forming apparatus 10 includes a paper feed unit 20 configured to feed a paper 100, an image forming unit 30 configured to form an image on the paper 100 with dry-type pigment 102, and a fuser 40 configured to fuse the dry-type pigment 102 on the paper 100. In addition, the image forming apparatus 10 includes an apparatus main body 8 configured to accommodate each unit 20, 30, and 40 therein, and a document scanning unit 9 configured to scan a document. In the present embodiment, the pigment 102 is a toner 102.

The paper feed unit 20 includes a cassette 25 configured to accommodate layered papers 100 therein and inserted in a lower part of the apparatus main body 8, and a pick-up roller 26 configured to feed a compressed uppermost paper 100 of the layered papers 100. In addition, the paper feed unit 20 includes a lifting plate 27 configured to press the paper 100 against the pick-up roller 26 by urging an end portion thereof upward, and a paper exit roller 28 configured to discharge the paper 100 on which the image has been formed by the image forming unit 30 and the fuser 40 towards a paper exit tray 81 of the apparatus main body 8.

The image forming unit 30 includes a cylindrical photoconductive drum 34 configured to form a photoconductor on a surface thereof, and a charger 35 configured to evenly charge the surface of the photoconductive drum 35. In addition, the image forming unit 30 includes an exposure unit 36 configured to expose the surface of the photoconductive drum 34 based on image data and the like scanned by the document scanning unit 9, and a developing unit 37 configured to cause the toner 102 to adhere to the surface of the photoconductive drum 34. Furthermore, the image forming unit 30 includes a transfer unit 38 configured to transfer the toner 102 that adheres to the surface of the photoconductive drum 34 to one surface of the paper 100.

As illustrated in FIG. 5, the fuser 40 includes a heating unit 50 configured to heat the toner 102 and the paper 100 from the one surface of the paper 100, and the microwave applicator 6 configured to heat the toner 102 and the paper 100 with microwaves. Furthermore, the fuser 40 includes a feed device 7 configured to feed the paper 100 along the feed direction Dl.

The heating unit 50 includes the heat roller 51 configured to make contact with the one surface of the paper 100 to heat the toner 102 and the paper 100 from the one surface of the paper 100. In addition, the heating unit 50 includes a press roller 55 configured to make contact with the other surface of the paper 100 to press the paper 100 against the heat roller 51.

The microwave applicator 6 includes the microwave generator 61, the power supply 62, the heat chamber 63, the tuner 64, and the isolator 65 (only the heat chamber 63 is illustrated in FIG. 5). Since configurations of each unit 6, and 61 to 65 are substantially same as configurations of each unit 6, and 61 to 65 according to the above-described first embodiment, redundant explanation will be omitted.

The feed device 7 includes a pair of feed belts 71, 72 configured to sandwich and feed the paper 100. In addition, the feed device 7 includes a plurality of (four in the present embodiment) feed rollers 73 with the first feed belt 71 provided around each outer circumference of the feed rollers 73 to cause the first feed belt 71 to travel, and a plurality of (four in the present embodiment) feed rollers 74 with the second feed belt 72 provided around each outer circumference of the feed rollers 74 to cause the second feed belt 72 to travel.

The pair of feed belts 71, 72 is arranged so as to pass through the pair of openings 63h, 63h provided in the heat chamber 63. The first feed belt 71 is in contact with the one surface of the paper 100, and the second feed belt 72 is in contact with the other surface of the paper 100. In the present embodiment, each feed belt 71, 72 is formed of polyimide film coated with polytetrafluoroethylene (PTFE).

As described above, with the image forming apparatus 10 according to the present embodiment, the image forming unit 30 forms the image on the one surface of the paper 100 with the toner 102, and the heating unit 50 heats the toner 102 and the paper 100 from the one surface of the paper 100. Then, the microwave applicator 6 arranged downstream of the heating unit 50 heats the toner 102 and the paper 100 with microwaves output from the microwave generator 61.

Consequently, an interior portion of the paper 100, the other surface of the paper 100, and the like that have not been sufficiently heated by the heating unit 50 can be heated. The toner 102 and the paper 100 thus can be efficiently heated.

The image forming apparatus according to the present invention is not limited to configurations of the above-described embodiments or effects described above, and it is needless to mention that various modifications may be made within the scope as long as these do not depart from the essence of the present invention. For example, each configuration and each method of the above-described embodiments may be freely adopted and combined, and each configuration and each method according to one exemplary embodiment may be applied to those according to other exemplary embodiments. It is also needless to mention that any of the configurations and the methods concerning the following modifications may be selected to apply to the configurations and the methods according to the above-described embodiments.

In the image forming apparatus 10 according to the above-described second embodiment, the heating unit 50 and the feed device 7 are mechanisms separated from each other. However, the image forming apparatus 10 according to the present invention is not limited to such a configuration. Specifically, in the image forming apparatus 10 according to the present invention, a part or all parts of the heating unit 50 and the feed device 7 may be used in common.

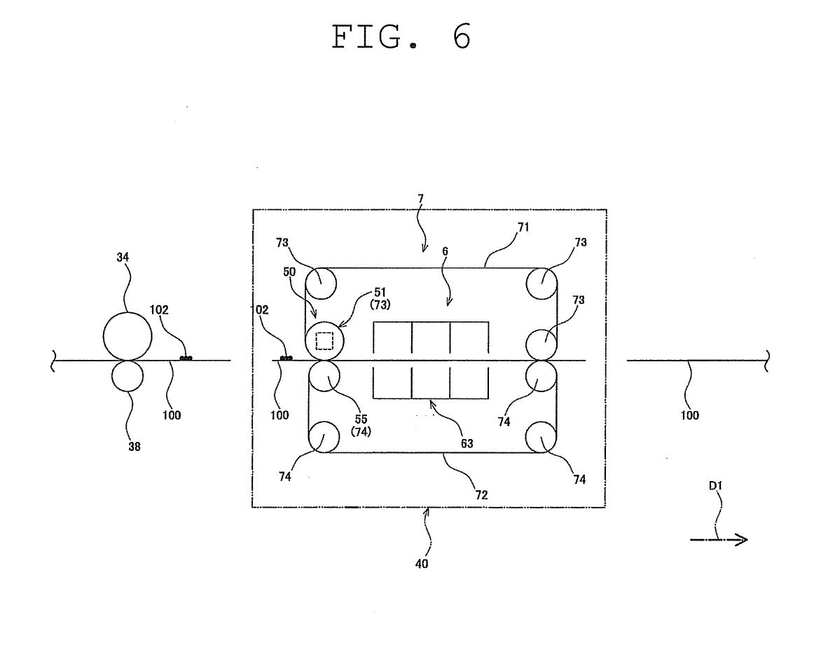

For example, in the image forming apparatus according to a further embodiment of the present invention, as illustrated in FIG. 6, the heat roller 51 of the heating unit 50 may double as the feed roller 73 to cause the first feed belt 71 to travel, and the press roller 55 of the heating unit 50 may double as the feed roller 74 to cause the second feed belt 72 to travel. With such a configuration, the heat roller 51 heats the paper 100 from the one surface via the first feed belt 71.

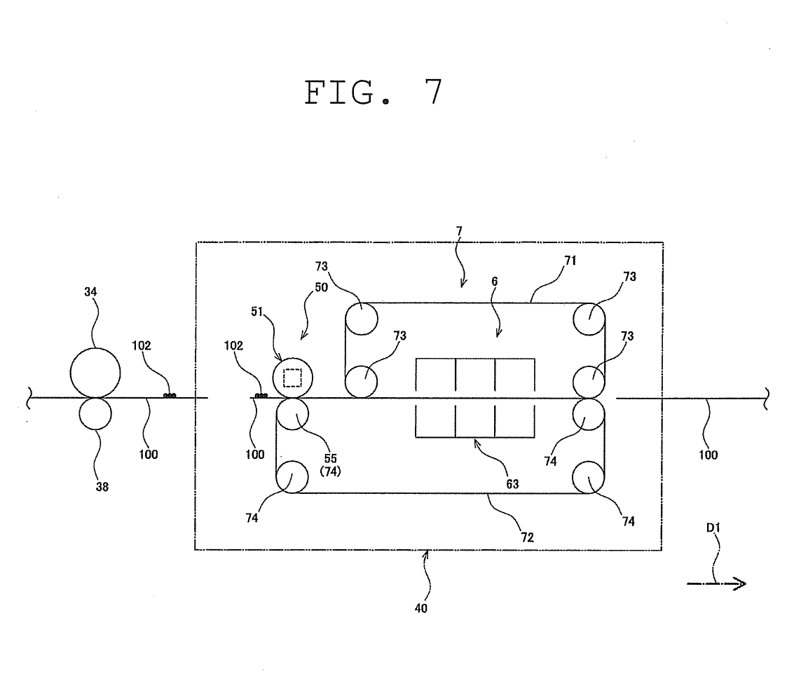

Furthermore, in the image forming apparatus according to a further embodiment of the present invention, as illustrated in FIG. 7, for example, the press roller 55 of the heating unit 50 may double as the feed roller 74 to cause the second feed belt 72 to travel. Although not illustrated, in the image forming apparatus according to the present invention, for example, the heat roller 51 of the heating unit 50 may double as the feed roller 73 to cause the first feed belt 71 to travel.

In the image forming apparatus 1 according to the above-described first embodiment, the heating unit 5 includes the heat roller 51 and the hot-air heater 52. In the image forming apparatus 10 according to the above-described second embodiment, the heating unit 50 includes the heat roller 51 and the press roller 55. However, the image forming apparatus according to the present invention is not limited to such configurations. For example, in the image forming apparatus according to the present invention, a heating unit may be formed only by the heat roller 51 or only by the hot-air heater 52. Alternatively, the heating unit may be formed of an infrared ray irradiation device using an electronic flash.

Furthermore, the image forming apparatus 1 according to the above-described first embodiment is an ink jet printing machine. The image forming apparatus 10 according to the above-described second embodiment is a toner printing machine. However, the image forming apparatus according to the present invention is not limited to such configurations. For example, the image forming apparatus according to the present invention may be a relief printing machine using a relief printing plate, an offset printing machine using a flat plate, an intaglio printing machine using an intaglio plate, or a stencil printing machine such as a silkscreen printing machine or a mimeograph.

While the present invention has been described with respect to embodiments thereof, it will be apparent to those skilled in the art that the disclosed invention may be modified in numerous ways and may assume many embodiments other than those specifically set out and described above. Accordingly, the appended claims cover all modifications that fall within the true spirit and scope of the present invention.

What is claimed is:

1. An image forming apparatus comprising:
an image forming unit configured to form an image on a paper with pigment;
a heating unit configured to heat the pigment and the paper from one or both surfaces of the paper;
a microwave generator; and
a microwave applicator arranged downstream of the heating unit and configured to heat the pigment and the paper by applying microwaves generated by the microwave generator.

2. The image forming apparatus according to claim 1, wherein
the image forming unit is configured to form the image on the one surface of the paper with wet-type pigment, and
the heating unit is configured to heat the pigment and the paper from the other or both surfaces of the paper.

3. The image forming apparatus according to claim 2, wherein the heating unit is a heat roller configured to heat the paper from the other or both surfaces of the paper.

4. The image forming apparatus according to claim 2, wherein the microwave applicator is configured to supply power to the microwave generator such that a temperature of the pigment is higher than a boiling temperature of a moisturizing agent contained in the pigment.

5. The image forming apparatus according to claim 1, wherein
the image forming unit is configured to form the image on the one surface of the paper with dry-type pigment, and
the heating unit is configured to heat the pigment and the paper from the one or both surfaces of the paper.

6. The image forming apparatus according to claim 5, wherein the heating unit is a heat roller configured to heat the paper from the one or both surfaces of the paper.

7. The image forming apparatus according to claim 1, comprising a pair of feed belts configured to sandwich and feed the paper, wherein
the microwave applicator includes a heat chamber to heat the pigment and the paper, the heat chamber being a chamber into which microwaves output from the microwave generator are introduced,
the heat chamber includes a pair of openings through which the paper passes an interior portion of the heat chamber, and
the pair of feed belts passes through the pair of openings.

8. The image forming apparatus according to claim 7, comprising a plurality of feed rollers with the feed belt provided around each outer circumference thereof to cause the pair of feed belts to travel, wherein
the heating unit is a heat roller configured to heat the paper from the one or both surfaces of the paper and is one of the plurality of feed rollers.

9. The image forming apparatus according to claim 8, wherein the feed belt is heat-resistant and has a mold release property.
